(19) United States
(12) Patent Application Publication
(10) Pub. No.: US 2007/0296734 A1
(43) Pub. Date: Dec. 27, 2007

(54) Method and apparatus for creating and managing high impact special effects

(76) Inventor: Frank Edughom Ekpar, Fukui City (JP)

Correspondence Address: FRANK EDUGHOM EKPAR, BUNKYO 3-14-1-401, FUKUI CITY, FUKUI, 910-0017, omitted

(21) Appl. No.: 11/473,879

(22) Filed: Jun. 26, 2006

(51) Int. Cl. G09G 5/00

(52) U.S. Cl. 345/619

(57) ABSTRACT

The present invention discloses a method and apparatus for creating and managing high impact special effects by composing one or more elemental and/or composite special effects into one or more composite special effects wherein said composition is carried out on the basis of rules specifying the number, relative positions, relative durations and/or other relevant attributes/behaviors of the individual elemental special effects and/or any other attributes/behaviors required to support a desired level of creativity and flexibility. According to the principles of the present invention, said composition of elemental special effects can be realized in a N-dimensional environment permitting composition in a non-linear fashion.

### CROSS-REFERENCE TO RELATED APPLICATIONS

This U.S. Non-Provisional Application claims the benefit of U.S. Provisional Application Ser. No. 60/692,962, file on Jun. 23, 2005, herein incorporated by reference.

### BACKGROUND OF THE INVENTION

1. Field of the Invention

The present invention relates generally to the field of special effects. In particular, the invention relates to a system permitting the creation of high impact special effects by composing one or more elemental special effects into one or more composite special effects.

2. Description of the Prior Art

Computer graphics and multimedia authoring tools and systems often provide in-built special effects that can be applied to transitions between elements such as two adjacent video clips in a video editing package. Special effects in existing systems are generally isolated or very hard to combine into composite effects in a meaningful manner.

### SUMMARY OF THE INVENTION

It is an object of the present invention to overcome the limitations of the prior art set forth above by providing a powerful way for individual elemental special effects to be creatively combined into high impact composite special effects. The principles of the present invention permit greater power and creativity in the composition of high impact special effects than are is possible with the prior art by permitting an arbitrary number and type of elemental and/or composite special effects to be combined based on suitably defined rules in an N-dimensional environment, where N can be 1, 2, 3 or any desired number.

### BRIEF DESCRIPTION OF THE DRAWINGS

FIG. 1 illustrates a simple embodiment of the present invention.

### DETAILED DESCRIPTION OF THE PREFERRED EMBODIMENTS

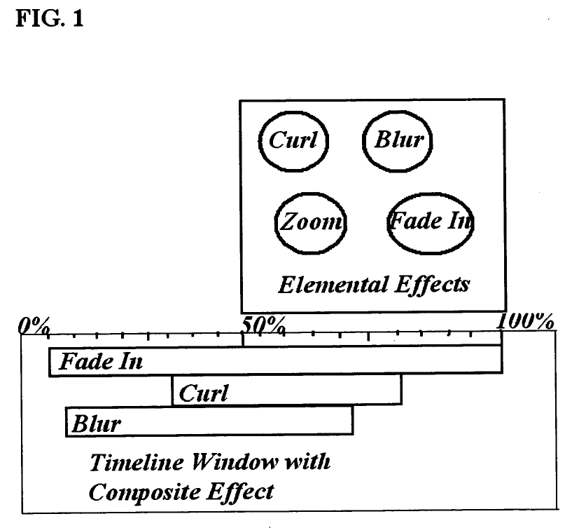

Referring now to FIG. 1, an illustration of a simple embodiment of the present invention, elemental special effects are indicated with icons and labels identifying the type of the effect. For example, the effect that specifies a fade-in transition between media elements is labeled “Fade In” in FIG. 1. The graphical user interface shown in FIG. 1 is designed to facilitate the composition of high impact special effects by combining available elemental special effects. It features a timeline window on which elemental special effects appear as horizontal slots on horizontal tracks. An arbitrary number of elemental special effects can be added simply by dragging the associated icon and dropping it onto the timeline window. Each slot on a track of the timeline window can independently be resized and re-positioned. The lengths and positions of the slots indicate the starting and ending of the special effects they represent as a percentage of the duration of the composite special effect they comprise. FIG. 1 depicts several elemental special effects positioned on the timeline window to create a composite special effect The example in FIG. 1 is a simple multidimensional composition with a potentially arbitrary number of tracks each of which may contain a potentially arbitrary number of arbitrarily positioned and sized slots each of which represents an elemental special effect. FIG. 1 depicts a graphical user interface that permits elemental special effects to be added and positioned by direct visual manipulation. Unwanted special effects can also be removed. The interface also features the ability to specify attributes (such as name, description, representative icon or video clip, etc) for the composite special effect and to store and retrieve a representation of the composite special effect.

According to the principles of the present invention, rules could be defined to control the composition of special effects, the rendering of the individual elemental special effects within the composition and/or any other attributes/behaviors required to permit the desired level of creativity and flexibility. The principles of the present invention permit far greater creativity and versatility in the creation and management of high impact special effects than is possible with the prior art.

It should be understood that numerous alternative embodiments and equivalents of the invention described herein may be employed in practicing the invention and that such alternative embodiments and equivalents fall within the scope of the present invention. Thus, it is intended that the appended claims define the scope of the invention and that methods and structures within the scope of these claims and their equivalents be covered thereby.

What is claimed is:

1. A method and apparatus for creating and managing high impact special effects by composing one or more elemental and/or composite special effects into one or more composite special effects wherein said composition is carried out on the basis of rules specifying the number, relative positions, relative durations and/or other relevant attributes/behaviors of the individual elemental special effects and/or any other attributes/behaviors required to support a desired level of creativity and flexibility in a N-dimensional environment permitting composition in a linear or non-linear fashion.
